(19) United States
(12) Patent Application Publication
(10) Pub. No.: US 2016/0227625 A1
(43) Pub. Date: Aug. 4, 2016

(54) LAMP BYPASS SWITCH

(71) Applicants: Wayne BENSON, NEWMARKET (CA); Varun CHANDAN, CALEDON (CA)

(72) Inventors: Wayne BENSON, NEWMARKET (CA); Varun CHANDAN, CALEDON (CA)

(21) Appl. No.: 15/013,423

(22) Filed: Feb. 2, 2016

Related U.S. Application Data
(60) Provisional application No. 62/110,880, filed on Feb. 2, 2015.

(51) Int. Cl. H05B 37/02

(52) U.S. Cl. CPC H05B 37/02

(57) ABSTRACT

Aspects of the present application relate to a bypass switch for a lamp, such as a surgical or diagnostic lamp. When activated, the bypass switch may act to allow electric power to bypass elements of a control board so that the electric power is provided to the plurality of lamp elements.

### CROSS-REFERENCE TO RELATED APPLICATIONS

The present application claims priority to U.S. Provisional Patent Application No. 62/110,880, filed Feb. 2, 2015, the contents of which are hereby incorporated herein by reference.

### FIELD

The present application relates generally to lamps and, more specifically, to a switch for bypassing lamp control electronics.

### BACKGROUND

Control for lamps, such as those lamps used in surgical and diagnostic settings, may currently extend well beyond the on/off control of days gone by. Especially when a lamp is comprised of a plurality of dimmable lamp elements, control for a given lamp may involve turning on or off individual ones of the lamp elements and even controlling the amount of light generated at each lamp element. However, the main control boards that facilitate this degree of control are not immune to failure.

### BRIEF DESCRIPTION OF THE DRAWINGS

Reference will now be made, by way of example, to the accompanying drawings which show example implementations; and in which:

FIG. 1 illustrates a lamp;

FIG. 2 illustrates, in block diagram form, the lamp of FIG. 1 and a plurality of control elements, one of the control elements including a button, in accordance with aspects of the present application; and

FIG. 3 illustrates the button of FIG. 2 on a swing arm, where the swing arm may be a support arm for the lamp of FIGS. 1.

### DETAILED DESCRIPTION

Aspects of the present application relate to a bypass switch for a lamp, such as a surgical or diagnostic lamp. When activated, the bypass switch may act to allow electric power to bypass elements of the circuitry of a main control board so that the electric power is provided to the plurality of lamp elements.

According to an aspect of the present disclosure, there is provided a lamp assembly. The lamp assembly includes a plurality of light sources, a source of electrical power, a control board, a fuse board configured to provide, in accordance with control signals received from the control board, the electrical power, received from the source of electrical power, to the light sources and a bypass switch configured to, responsive to activation, transmit an override signal to the fuse board, wherein the fuse board is configured to, responsive to receipt of the override signal, provide the electrical power, received from the source of electrical power, to the light sources without regard to the control signals received from the control board.

Other aspects and features of the present disclosure will become apparent to those of ordinary skill in the art upon review of the following description of specific implementations of the disclosure in conjunction with the accompanying figures.

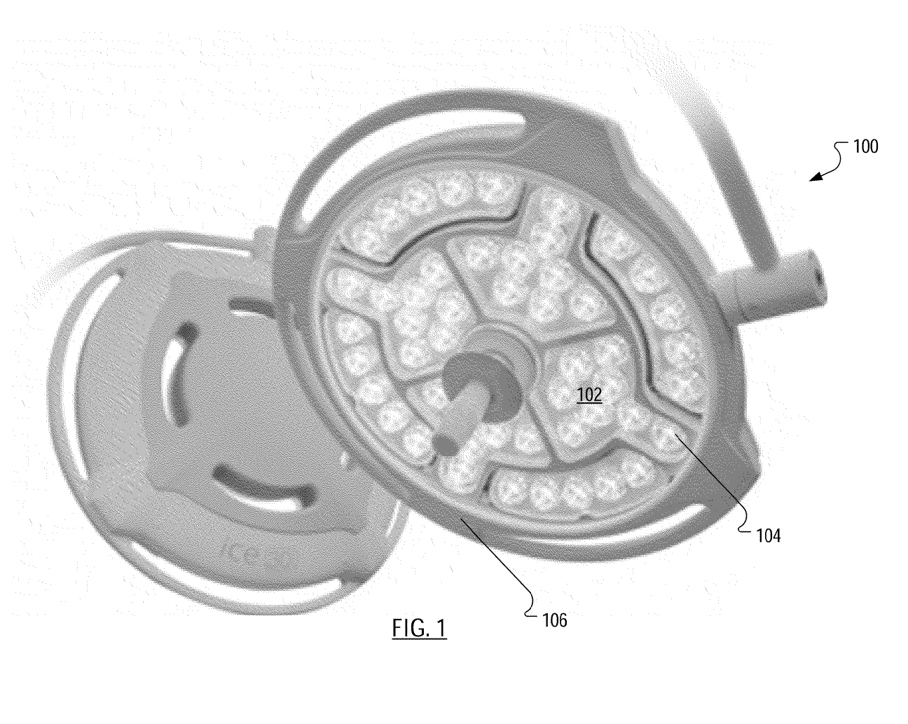

FIG. 1 illustrates a lamp 100 having a plurality of lamp element assemblies 102. Mounted on each lamp element assembly 102 of the plurality of lamp element assemblies 102 is a plurality of lamp elements 104. The lamp element assemblies 102 may be mounted within a lamp head 106.

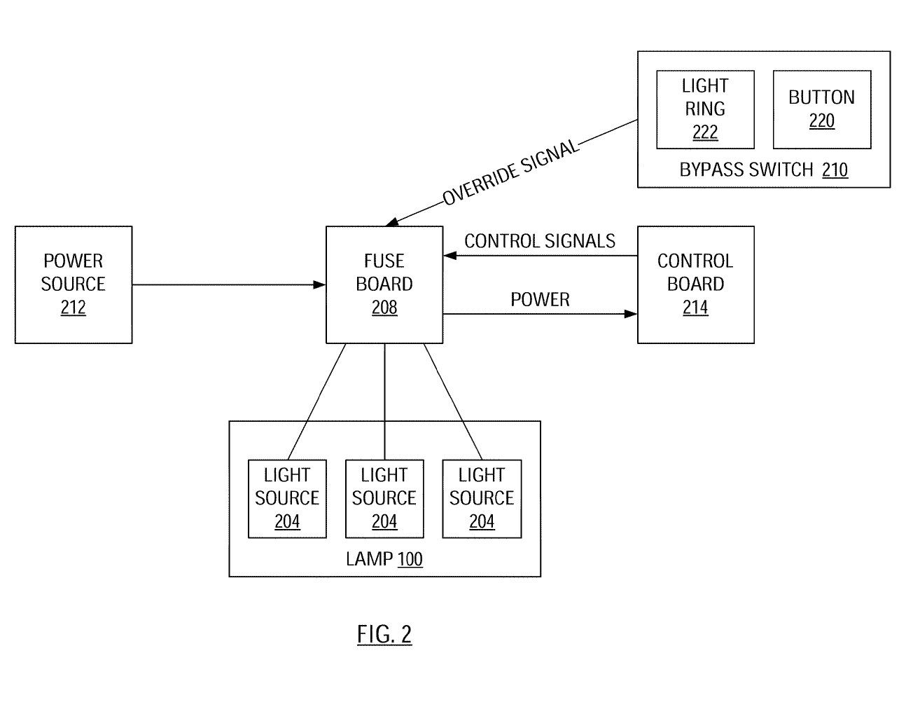

FIG. 2 illustrates, in block diagram form, the lamp 100 of FIG. 1 and a plurality of control elements. The lamp 100 includes a plurality of dimmable light sources 204. Each of the light sources 204 may be considered to be a component of a lamp element 104 of FIG. 1. The light sources 204 are configured to receive electrical power from a fuse board 208. The fuse board 208 may be communicatively connected to a control board 214. In particular, the fuse board 208 may provide power to the control board 214 and receive control signals from the control board 214.

The fuse board 208 is configured to receive electrical power from a power source 212.

Associated with, and communicatively connected to, the emergency bypass switch 210 are a button 220 and a light ring 222.

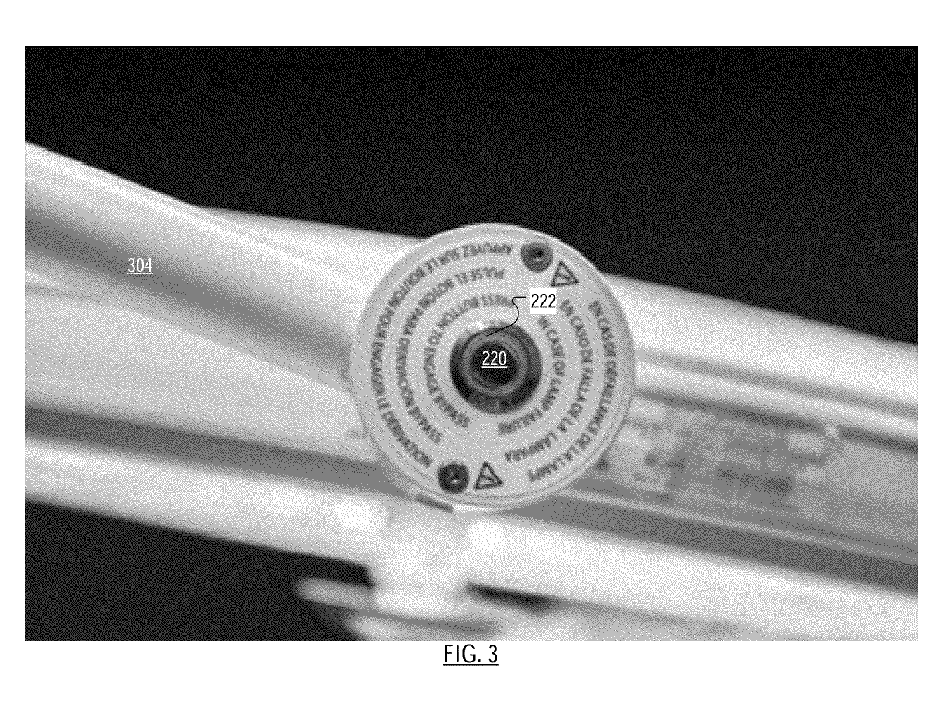

FIG. 3 illustrates the button 220 on a swing arm 304. The swing arm 304 may be, for example, a support arm for the lamp 100. The button is surrounded by the light ring 222.

In overview, aspects of the present application relate to the bypass switch 210 for the lamp 100, which may be a surgical or diagnostic lamp. The bypass switch 210 may be configured for use during emergencies, when the lamp 100 may be inoperable due a failure related to the control board 214.

In routine operation, the dimmable light sources 204 are configured to receive electrical power from the fuse board 208. A matter of which of the plurality of light sources 204 receives electrical power and the quantity of power may be determined, at the fuse board 208, based on control signals received, at the fuse board 208, from the control panel 214. The control panel 214 may generate such control signals, based upon manipulation by a user of the lamp 100, and transmit such control signals to the fuse board 208. More particularly, the control signals from the control panel 214 may be implemented as pulse width modulated signals, with the width of the pulse being representative of a degree to which individual ones of the dimmable light sources 204 are to be dimmed. Indeed, the degree of dimming may range from 0% to 100%. Elements (not shown) of the circuitry of the fuse board 208 control the degree of dimming of the individual ones of the dimmable light sources 204 based upon the control signals received from the control panel 214.

As stated hereinbefore, it is generally unlikely that the control board 214 is immune to failure. Failure of the control board 214 may lead to apparent inoperability of the lamp 100.

Upon detecting apparent inoperability of the lamp 100, a user of the lamp 100 may activate the bypass switch 210. The user of the lamp 100 may, for example, activate the bypass switch 210 by pressing the button 220 (see FIG. 3) on the swing arm 304.

The bypass switch 210, responsive to having been activated, transmits an override signal to the fuse board 208. At the fuse board 208, the effect of receipt of the override signal from the bypass switch is to allow the electrical power provided by the power source 212 to bypass the elements of the circuitry of the fuse board 208 that control the degree of dimming of the individual ones of the dimmable light sources 204 such that the electrical power proceeds to the plurality of light sources 204 with 0% dimming. As a result of not passing through elements of the circuitry of the fuse board 208, the electrical power provided to the plurality of light sources 204 lacks any attenuation (dimming) or individual light source control. As such, responsive to activation of the bypass switch 210, all of the light sources 204 may be configured to turn on and glow at full power.

Further responsive to activation of the bypass switch 210, the light ring 222 may be illuminated, thereby providing an indication that the bypass switch 210 has been activated.

Accidental activation of the bypass switch 210 may not be possible to avoid. However, through the illumination of the light ring 222, a user can readily observe whether the bypass switch 210 has been activated. Such an observation may serve as a clue as to why the lamp 100 is not reacting appropriately to user attempts at control via the control board 214.

Conveniently, when mounted on the swing arm 304, the bypass switch 210 is easily accessible. Other easily accessible locations are also contemplated, including on the lamp head 106 or any other connecting components.

The above-described implementations of the present application are intended to be examples only. Alterations, modifications and variations may be effected to the particular implementations by those skilled in the art without departing from the scope of the application, which is defined by the claims appended hereto.

What is claimed is:

1. A lamp assembly comprising:
a plurality of light sources;
a source of electrical power;
a control board;
a fuse board configured to provide, in accordance with control signals received from the control board, the electrical power, received from the source of electrical power, to the light sources; and
a bypass switch configured to, responsive to activation, transmit an override signal to the fuse board;
wherein the fuse board is configured to, responsive to receipt of the override signal, provide the electrical power, received from the source of electrical power, to the light sources without regard to the control signals received from the control board.

2. The lamp assembly of claim 1 wherein the control panel is configured to:
generate, based upon user manipulation, the control signals; and
transmit, to the fuse board, the control signals.

3. The lamp assembly of claim 2 wherein the control signals comprise pulse width modulation signals.

4. The lamp assembly of claim 1 wherein the bypass switch further comprises a button for selective activation of the bypass switch.

5. The lamp assembly of claim 3 further comprising a light ring wherein the bypass switch is configured to, responsive to activation, provide electrical power to the light ring.

6. The lamp assembly of claim 5 further comprising a lamp head, wherein the light sources are mounted within the lamp head.

7. The lamp assembly of claim 6 further comprising a swing arm configured to support the lamp head.

8. The lamp assembly of claim 7 wherein the button is mounted to the swing arm.

9. The lamp assembly of claim 8 wherein the light ring surrounds the button.
